(19) United States
(12) Patent Application Publication
(10) Pub. No.: US 2025/0139321 A1
(43) Pub. Date: May 1, 2025

(54) METHOD AND SYSTEM FOR DEFINING A DIGITAL TWIN OF AN AIRCRAFT INTENDED TO IMPROVE A DESIGN OF AN AIRCRAFT STRUCTURE IN ORDER TO CONTRIBUTE TO THE FIGHT AGAINST CORROSION OF THE AIRCRAFT STRUCTURE

(71) Applicants: Airbus Operations (S.A.S.), Toulouse (FR); Airbus Operations GmbH, Hamburg (DE)

(72) Inventors: Martin Beneke, Hamburg (DE); Alexandra Luce, Hamburg (DE); Romain Ecault, Toulouse (FR); Marine Chesneau, Toulouse (FR)

(21) Appl. No.: 18/929,892

(22) Filed: Oct. 29, 2024

(30) Foreign Application Priority Data
Oct. 30, 2023 (FR) 2311808

(51) Int. Cl. G06F 30/15; G06F 30/20

(52) U.S. Cl. CPC G06F 30/15; G06F 30/20

(57) ABSTRACT

A method and system for defining a digital twin of an aircraft to improve a design of an aircraft structure to contribute to the fight against corrosion of the aircraft structure includes a step of collecting corrosion incidents on aircrafts, a step of determining zones associated with a corrosion risk level for each part, a definition step for defining a category of corrosion protection for each zone according to the corrosion risk level associated with each of the zones. The method makes it possible to define the corrosion protection treatment requirements of the aircraft structure more precisely.

### TECHNICAL FIELD

The disclosure herein relates to a method for defining a digital twin of an aircraft intended to improve a design of an aircraft structure, for example of a fuselage or of the wings of an aircraft, in order to contribute to the fight against corrosion of the aircraft structure.

### BACKGROUND

Currently, when an aircraft is being manufactured, the parts of the aircraft structure, and in particular of the wings or of the fuselage of the aircraft, are subjected to different corrosion protection levels. This protection depends, inter alia, on the location and the function of the parts.

For example, the fuselage parts situated in the lower part of the aircraft generally require a higher corrosion protection than the protection for the parts situated in the upper part of the aircraft. Similarly, the moving fuselage parts, such as the doors or the landing gear box, generally require a greater corrosion protection than the protection for the fixed fuselage parts.

There are currently different corrosion protection levels, namely, in ascending order of increase from the lowest to the highest: level 1, level 2, level 3 and level 4.

The corrosion protection is established at the individual part level and

at the assembly level.

The protection afforded at the individual part level comprises four levels.

Level 1 comprises a surface treatment, such as tribofinishing, cadmium plating, anodization, galvanization, etc. Level 1 also comprises an installation without mastic.

Level 2 comprises a surface treatment and one coat of paint. Level 2 also comprises an installation with mastic interposed between two parts.

Level 3 comprises a surface treatment and two coats of paint. Level 3 also comprises an installation with mastic interposed between two parts, and also a bead of mastic over the entire perimeter.

Level 4 comprises a surface treatment, two coats of paint and a waterproofing treatment. Level 4 also comprises an installation with mastic interposed between two parts, and also a bead of mastic covering the edges.

Moreover, the fuselage parts are classified in different categories according to their need for corrosion protection: category 1, category 2, category 3, category 4 and category 5.

Category 1 comprises the parts and the assemblies which require little corrosion protection (level 1 to 2).

Category 2 comprises the parts which require the protection level 2 and the assemblies which require the protection level 3.

Categories 3 and 4 comprise the parts and the assemblies which require the protection level 3.

Category 5 comprises the parts and the assemblies which require the protection level 3 or 4.

There is currently a two-dimensional mapping of the aircraft indicating the corrosion zones and the respective protection categories of each of the fuselage parts (FIG. 2).

However, this mapping is fixed, and is not necessarily optimal.

The maximum corrosion protection is applied to all of a fuselage part, even if only a portion of this fuselage part should be subjected to the maximum treatment against corrosion. There are therefore losses in terms of weight (parts heavier because of the treatments), materials (paint used) and costs (labour for the treatment of the parts, and time to manufacture the parts) on these fuselage parts because of the fixed and non-optimized mapping.

Furthermore, certain portions of a fuselage part (for example at the fixings) are not necessarily correctly taken into account in defining the protection level necessary for the entire part, and therefore the part should not necessarily belong entirely to the category in which it is classified. There is therefore much in-service feedback on these parts. The current fixed mapping is not therefore fully satisfactory.

### SUMMARY

The object of the disclosure herein is to overcome the drawbacks set out above.

For this, it relates to a method for defining a digital twin of an aircraft intended to improve a design of an aircraft structure in order to contribute to the fight against corrosion of the aircraft structure, the digital aircraft twin presenting a three-dimensional digital model virtually defining the aircraft structure comprising parts of the aircraft structure.

According to the disclosure herein, the method comprises the following steps:
a collection step implemented by a collecting unit for collecting a plurality of corrosion incidents on a plurality of aircraft,
a reporting step implemented by a reporting unit for reporting the plurality of corrosion incidents collected on the digital twin,
a first determination step implemented by a first determining unit for determining zones associated with a corrosion risk level for each part of the aircraft structure of the digital twin, the corrosion risk level of each of the zones being determined on the basis of the corrosion incidents collected in each of the zones respectively,
a definition step implemented by a defining unit for defining the digital twin by defining a corrosion protection category for each zone according to the corrosion risk level associated with each of the zones,
a transmission step implemented by a transmitting unit for transmitting the digital twin to a user device.

Thus, the zones of the aircraft structure requiring a particular corrosion protection treatment are identified on the basis of in-service feedback data and not on the basis of a fixed mapping. The protection treatment requirements of the aircraft structure are now more precise. The protection treatments are defined not only for a part of the aircraft structure but for zones of parts of the aircraft structure determined on the basis of in-service feedback data.

According to one embodiment, the first determination step comprises the following sub-steps:
a first cutting sub-step implemented by a first cutting sub-unit for cutting each part of the aircraft structure according to a mesh of zones comprising zones of predetermined size,
   a first computation sub-step implemented by a first computing sub-unit for calculating a corrosion incident rate for each zone of the mesh of zones,
a second computation sub-step implemented by a second computing sub-unit for calculating, in each zone of the mesh of zones of a part, a corrosion risk level according to the corrosion incident rate calculated for the zone.

Furthermore, the first determination step further comprises the following sub-steps implemented if at least two zones of the mesh of zones of a part show a corrosion incident rate difference greater than a predetermined difference:
a second cutting sub-step implemented by a second cutting sub-unit for cutting the part according to a sub-mesh of zones comprising zones of predetermined size less than the predetermined size of the zones of the zone mesh,
a third computation sub-step implemented by a third computing sub-unit for calculating a corrosion incident rate for each zone of the sub-mesh of zones,
a fourth computation sub-step implemented by a fourth computing sub-unit for calculating, in each zone of the sub-mesh of zones of the part, a corrosion risk level according to the corrosion incident rate calculated for each zone of the zone sub-mesh.

According to another embodiment, the method further comprises a second determination step implemented by a second determining unit for determining at least one characteristic likely to cause corrosion in each of the zones,
the definition step being implemented to define the digital twin by further defining a type of protection according to the characteristic likely to cause corrosion in each of the zones.

According to a first variant, the second determination step comprises the following sub-steps:
an evaluation sub-step implemented by an evaluating sub-unit for evaluating, for each zone of a part, at least one galvanic incompatibility between materials from which each part is likely to be manufactured, the materials being given by the digital twin,
a first definition sub-step implemented by a first defining sub-unit for defining at least one galvanic incompatibility between the materials as being a characteristic likely to cause corrosion in a zone if the galvanic incompatibility or incompatibilities evaluated are greater than or equal to a predetermined galvanic incompatibility.

Furthermore, the type of protection defined in the definition step corresponds to a type of protection suited to the galvanic incompatibility or incompatibilities evaluated in the evaluation sub-step if the galvanic incompatibility or incompatibilities between the materials are defined as being a characteristic likely to cause corrosion.

According to a second variant, the second determination step comprises the following sub-steps:
a first simulation sub-step implemented by a first simulating sub-unit for simulating, on the digital aircraft twin, movements likely to be undergone by the parts during normal use of an aircraft, a first detection sub-step implemented by a first detecting sub-unit for detecting an initiation of corrosion in each zone in a protective coating covering the parts following the movements simulated in the first simulation sub-step,
a second definition sub-step implemented by a second defining sub-unit for defining, as a characteristic likely to cause corrosion in a zone, at least an inadequacy of solidity of the protective coating if corrosion has appeared in the zone during the first simulation sub-step and been detected in the first detection sub-step.

Furthermore, the type of protection defined in the definition step corresponds to a suitable type of protection against the initiation of corrosion if the inadequacy or inadequacies of solidity of the protective coating are defined as being a characteristic likely to cause corrosion.

According to a third variant, the second determination step comprises the following sub-steps:
a second simulation sub-step implemented by a second simulating sub-unit for simulating, on the digital aircraft twin, a use of the aircraft under different atmospheric conditions,
a second detection sub-step implemented by a second detecting sub-unit for detecting, in each zone, at least one structural form likely to lead to corrosion following the second simulation sub-step,
a third definition sub-step implemented by a third defining sub-unit for defining, as a characteristic likely to cause corrosion in a zone, the structural form or forms likely to accumulate an electrolyte (corrosive fluid).

Furthermore, the type of protection defined in the definition step corresponds to a modification of the structural form or forms likely to accumulate an electrolyte in order for them to be no longer likely to accumulate an electrolyte if the structural form or forms likely to accumulate an electrolyte are defined as being a characteristic likely to cause corrosion.

The disclosure herein relates also to a system for defining a digital aircraft twin intended to improve a design of an aircraft structure in order to contribute to the fight against corrosion of the aircraft structure, the digital aircraft twin presenting a three-dimensional digital model virtually defining the aircraft structure comprising parts of the aircraft structure.

According to the disclosure herein, the system comprises:
a collecting unit for collecting a plurality of corrosion incidents on a plurality of aircraft,
a reporting unit for reporting the plurality of corrosion incidents collected on the digital twin,
a first determining unit for determining zones associated with a corrosion risk level of each part of the aircraft structure of the digital twin, the corrosion risk level of each of the zones being determined on the basis of the corrosion incidents collected in each of the zones respectively,
a defining unit for defining the digital twin by defining a corrosion protection category for each zone according to the corrosion risk level associated with each of the zones,
a transmitting unit for transmitting the digital twin to a user device.

Moreover, the system further comprises a second determining unit for determining at least one characteristic likely to cause corrosion in each of the zones.

### BRIEF DESCRIPTION OF THE DRAWINGS

The attached figures will give a good understanding of how the disclosure herein can be realized. In these figures, identical references denote similar elements.

FIG. 1 schematically represents the definition method.

FIG. 2 represents a two-dimensional fixed mapping of an aircraft showing fuselage parts to which protection categories have been assigned.

FIG. 3 represents a part of a digital aircraft twin on which collected corrosion incidents have been added.

FIG. 4 represents three figures, including a FIG. 4(A) which represents a transverse cross section of a region at risk having a structural gutter form 8 against the surface of the fuselage. FIG. 4(B) presents a first example of modification of the structural form of FIG. 4(A). FIG. 4(C) presents a second example of modification of the structural form of FIG. 4(A).

FIG. 5 schematically represents the definition system.

FIG. 6 represents a profile view of an aircraft of the plurality of aircraft on which the corrosion incidents are collected.

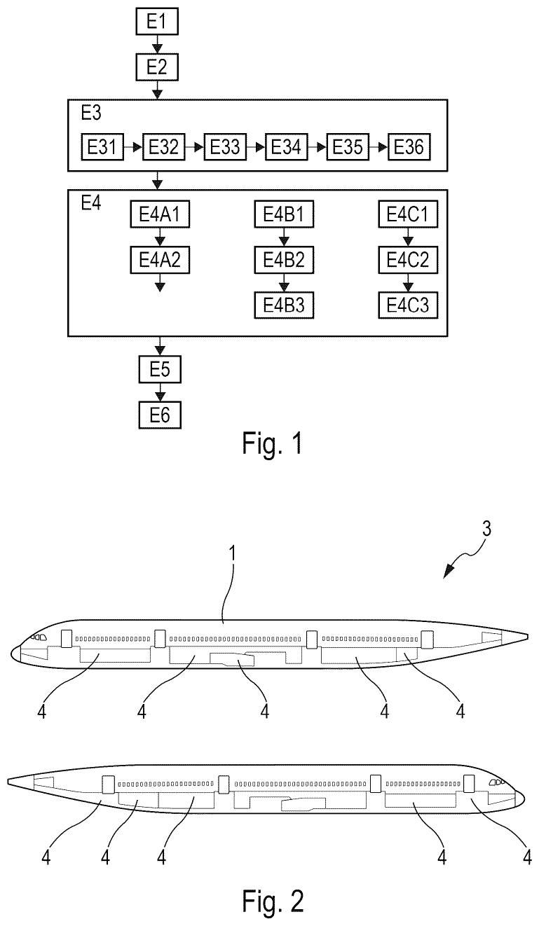

### DETAILED DESCRIPTION

The definition method is represented schematically in FIG. 1.

The definition method makes it possible to improve the design of an aircraft structure, or of a part of an aircraft, including wings and a fuselage 1 of an aircraft AC (FIG. 6) to contribute to the fight against corrosion of the aircraft structure. The aircraft structure is defined here as being the mechanical structure of the aircraft AC, also called “airframe” of the aircraft AC. Hereinafter in the description, the method will be described for a fuselage, but it is obviously applicable to the other elements of the structure of the aircraft, such as the wings.

The definition method is implemented to define a digital twin 2 of an aircraft having a fuselage 1 comprising fuselage parts 4.

The digital twin 2 corresponds to a three-dimensional modeling of an aircraft AC. This modeling can be implemented by a processor of a calculator, such as a computer.

The improvement method comprises at least the following steps:
a collection step E1 implemented by a collecting unit COL 11 (COL for “collecting unit”),
a reporting step E2 implemented by a reporting unit REP 111 (REP for “reporting unit”),
a first determination step E3 implemented by a first determining unit DET1 12 (DET for “determining unit”),
a definition step E5 implemented by a defining unit DEF 14 (DEF for “defining unit”),
a transmission step E6 implemented by a transmitting unit TRANS (TRANS for “transmitting unit”).

The collection step E1 is intended to be implemented to collect a plurality of corrosion incidents 6 on a plurality of aircraft AC. For example, in this collection step E1, the plurality of corrosion incidents are collected and stored in a database DB 15 (DB for “database”). The collecting unit 11 can correspond to an input device, such as a keyboard. The database can thus combine the in-service feedback from the plurality of aircraft AC.

“Corrosion incident” is the term used to refer to a region or zone of the fuselage 1 which is affected by corrosion. The corrosion incident comprises at least the position on the fuselage 1 of the region which includes the corrosion. The position can correspond to a position of a corroded surface.

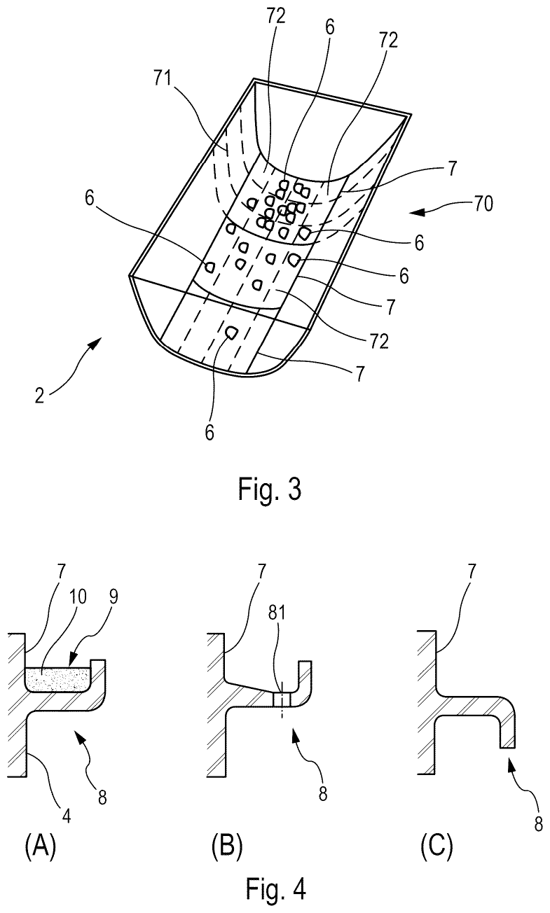

The reporting step E2 is intended to be implemented to report the plurality of corrosion incidents 6 collected on the digital twin 2. Thus, each of the corrosion incidents 6 is reported on the digital twin 2 at their respective position (FIG. 3). FIG. 3 represents a fuselage part 4 of the digital twin or else a portion of the fuselage of the digital twin 2.

The first determination step E3 is intended to be implemented to determine zones 7, 72 associated with a corrosion risk level for each part 4 of the fuselage of the digital twin 2. The corrosion risk level associated with each of the zones 7, 72 is determined on the basis of the corrosion incidents 6 collected in the collection step E1 in each of the zones 7, 72 respectively.

A corrosion risk level associated with a zone 7, 72 can correspond to a level on a corrosion incident rate scale or, in other words, to a corrosion incident rate interval within which the corrosion incident rate of the zone 7, 72 lies.

The corrosion incident rate of each of the zones 7, 72 is equal to a ratio between a number of corrosion incidents 6 collected in each of the zones 7, 72 of the plurality of aircraft AC and a number of aircraft AC equal to the number of aircraft AC of the plurality of aircraft AC. Preferably, this corrosion incident rate is determined for a hundred aircraft. This corrosion incident rate can also be determined over the entire fleet of aircraft.

For example, a corrosion incident rate strictly below 10% corresponds to a low corrosion risk level. A corrosion incident rate lying between 10% and 20% inclusive corresponds to a moderate corrosion risk level. A corrosion incident rate strictly above 20% corresponds to a high corrosion risk level.

The definition step E5 is intended to be implemented to define the digital twin 2 by defining at least one corrosion protection category for each zone 7, 72 according to the corrosion risk level associated with each of the zones 7, 72 determined for each zone 7, 72.

For example, the protection categories correspond to the categories 1, 2, 3, 4 and 5 described above.

The transmission step E6 is intended to be implemented to transmit to a user device USER 17 (USER for “user device”) the digital twin 2 defined in the definition step E5.

The user device 17 can comprise a display device intended to display the defined digital twin 2.

According to one embodiment, the first determination step E3 comprises the following sub-steps:
a first cutting sub-step E31 implemented by a first cutting sub-unit CUT1 121 (CUT for “cutting unit”),
a first computation sub-step E32 implemented by a first computing sub-unit COMP1 122 (COMP for “computing unit”),
a second computation sub-step E33 implemented by a second computing sub-unit COMP2 123.

The first cutting sub-step E31 is intended to be implemented to cut each part 4 of the fuselage 1 according to a mesh of zones 70 comprising zones 7 of predetermined size.

The mesh of zones 70 can correspond to a mesh having cells of square form or any other form suited to the part 4. These cells correspond to the zones 7.

FIG. 3 represents a mesh of zones 70 in solid lines. This mesh of zones 70 defines the zones 7. The predetermined size of the zones 7 depends on the precision that is desired to determine the corrosion risk levels associated with the zones 7. The zones 7 of the mesh of zones 70 can have a size smaller than the size of a fuselage part 4.

The first computation sub-step E32 is intended to be implemented to calculate the corrosion incident rate for each zone 7 of the mesh of zones 70.

For example, in FIG. 3, the zone mesh 70 has cut the part 4 into three zones 7.

The second computation sub-step E33 is intended to be implemented to calculate, for each zone 7 of the mesh of zones 70 of a part 4, a corrosion risk level according to the corrosion incident rate calculated for the zone 7.

The first determination step E3 can further comprise the following sub-steps:
a second cutting sub-step E34 implemented by a second cutting sub-unit CUT2 124,
a third computation sub-step E35 implemented by a third computing sub-unit COMP3 125,
a fourth computation sub-step E36 implemented by a fourth computing sub-unit COMP4 126.

These following sub-steps are intended to be implemented if at least two zones 7 of the zone mesh 70 of a part 4 show a corrosion incident rate difference greater than a predetermined difference.

The second cutting sub-step E34 is intended to be implemented to cut the part 4 according to a sub-mesh of zones 71 comprising zones 72 of predetermined size less than the predetermined size of the zones 7 of the zone mesh 70.

For example, a zone 7 of the mesh of zones 70 is cut by a sub-mesh of zones 71 comprising zones 72. As for the mesh of zones 70, the sub-mesh of zones 71 can correspond to a mesh having cells of square form or any other form suited to the part 4 or to the cells of the mesh of zones 70. These cells of the sub-mesh of zones 71 correspond to the zones 72.

For example, FIG. 3 presents, in dotted lines, a sub-mesh of zones 71 comprising zones 72 having a size less than the size of the zones 7.

The third computation sub-step E35 is intended to be implemented to calculate a corrosion incident rate for each zone 72 of the sub-mesh of zones 71.

The fourth computation sub-step E36 is intended to be implemented to calculate, for each zone 72 of the sub-mesh of zones 71 of the part 4, a corrosion risk level according to the corrosion incident rate calculated for each zone 72 of the sub-mesh of zones 71.

According to another embodiment, the method can further comprise a second determination step E4 implemented by a second determining unit DET2 13 to determine, in each of the zones 7, 72, at least one characteristic likely to cause corrosion.

In this embodiment, the definition step E5 is intended to be implemented to define the digital twin 2 by further defining a type of protection according to the characteristic likely to cause corrosion in each of the zones 7, 72. The type of protection defined makes it possible to eliminate the characteristic or characteristics likely to cause corrosion.

According to a first variant, the second determination step E4 comprises the following sub-steps:
an evaluation sub-step E4A1 implemented by an evaluating sub-unit EVAL 131 (EVAL for “evaluating unit”),
a first definition sub-step E4A2 implemented by a first defining sub-unit DEF1 132.

The evaluation sub-step E4A1 is intended to be implemented to evaluate, for each zone of a part 4, at least one galvanic incompatibility between materials from which each part 4 is likely to be manufactured. The materials are given by the digital twin 2.

Indeed, two different materials (such as different metals) in contact with one another in a corrosive atmosphere (such as a wet atmosphere) and exhibiting great potential differences can be subject to corrosion. The galvanic incompatibility is equal to the potential difference between two materials. The greater the potential difference, the greater the galvanic incompatibility.

On a fuselage 1 or a part 4 of the fuselage 1, different materials can be encountered that are in contact in zones of the fuselage 1 having fixing elements such as rivets. They can also be found in zones of contact between a fuselage skin and fuselage 1 stiffeners, spars or stringers.

The first definition sub-step E4A2 is intended to be implemented to define at least one galvanic incompatibility between the materials as being a characteristic likely to cause corrosion in a zone 7, 72 if the evaluated galvanic incompatibility or incompatibilities are greater than or equal to a predetermined galvanic incompatibility.

In this first variant, the type of protection defined in the definition step E5 corresponds to a protection type suited to the galvanic incompatibility or incompatibilities evaluated in the evaluation sub-step E4A1 if the galvanic incompatibility or incompatibilities between the materials are defined as being a characteristic likely to cause corrosion.

According to a second variant, the second determination step E4 comprises the following sub-steps:
a first simulation sub-step E4B1 implemented by a first simulating sub-unit SIM1 133 (SIM for “simulating unit”),
a first detection sub-step E4B2 implemented by a first detecting sub-unit DETECT1 134 (DETECT for “detecting unit”),
a second definition sub-step E4B3 implemented by a second defining sub-unit DEF2 135.

The first simulation sub-step E4B1 is intended to be implemented to simulate, on the digital aircraft twin 2, movements likely to be undergone by the parts 4 during normal use of an aircraft AC.

The first detection sub-step E4B2 is intended to be implemented to detect an initiation of corrosion in a protective coating covering the parts 4 following the movements simulated in the simulation step E4B1.

The second definition sub-step E4B3 is intended to be implemented to define, as a characteristic likely to cause corrosion in a zone 7, 72, at least one inadequacy of solidity of the protective coating if corrosion has appeared in the zone 7, 72 during the first simulation sub-step E4B1 and been detected in the first detection sub-step E4B2. The inadequacy of solidity can correspond to an insufficient thickness of the protective coating or else to a material of the coating which is not suited to bending and/or compressive part movements.

In this second variant, the type of protection defined in the definition step E5 corresponds to a suitable type of protection against the initiation of corrosion if the inadequacy or inadequacies of solidity of the protective coating are defined as being a characteristic likely to cause corrosion.

According to a third variant, the second determination step E4 comprises the following sub-steps: .
a second simulation sub-step E4C1 implemented by a second simulating sub-unit SIM2 136,
a second detection sub-step E4C2 implemented by a second detecting sub-unit DETECT2 137,
a third definition sub-step E4C3 implemented by a third defining sub-unit DEF3 138.

The second simulation sub-step E4C1 is intended to be implemented to simulate, on the digital aircraft twin 2, use of the aircraft AC under different atmospheric conditions. Preferably, the atmospheric conditions in which the simulation is implemented can correspond to atmospheric conditions for which water can accumulate on the fuselage 1 of an aircraft AC.

The second detection sub-step E4C2 is intended to be implemented to detect, in each zone 7, 72, at least one structural form 8 likely to lead to an accumulation of corrosive material, namely of an electrolyte 10 following the simulation sub-step E4C1. A structural form 8 in a zone 7, 72 can correspond to a three-dimensional geometry of the zone 7, 72.

For example, FIG. 4 shows a FIG. 4(A) which represents a transverse cross section of a zone 7 having a structural form 8 of a gutter 9 against the surface of the fuselage 1.

Generally, an electrolyte corresponds to a conductive liquid. In the example of FIG. 4(A), the electrolyte 10 has accumulated in the gutter against the surface of the fuselage 1.

The third definition sub-step E4C3 is intended to be implemented to define, as a characteristic likely to cause corrosion in a zone 7, 72, the structural form or forms 8 likely to accumulate an electrolyte 10.

The type of protection defined in the definition step E5 corresponds to a modification of the structural form or forms 8 likely to accumulate an electrolyte 10 in order for them to be no longer likely to accumulate electrolyte 10 if the structural form or forms 8 likely to accumulate electrolyte 10 are defined as being a characteristic likely to cause corrosion.

The structural form 8 can be modified in order for it no longer to be likely to accumulate an electrolyte 10.

FIG. 4(B) presents a first example of modification of the structural form 8 of FIG. 4(A). In this FIG. 4(B), the modification consists in forming an aperture in the gutter in order for the electrolyte to be evacuated therefrom. FIG. 4(C) presents a second example of modification of the structural form 8 of FIG. 4(A). In this FIG. 4(C), the modification consists in inverting the form of the gutter 9 in order for the electrolyte not to be able to accumulate.

The embodiments and the variants can be combined with one another. The steps and sub-steps implemented in the two embodiments can be implemented simultaneously or sequentially.

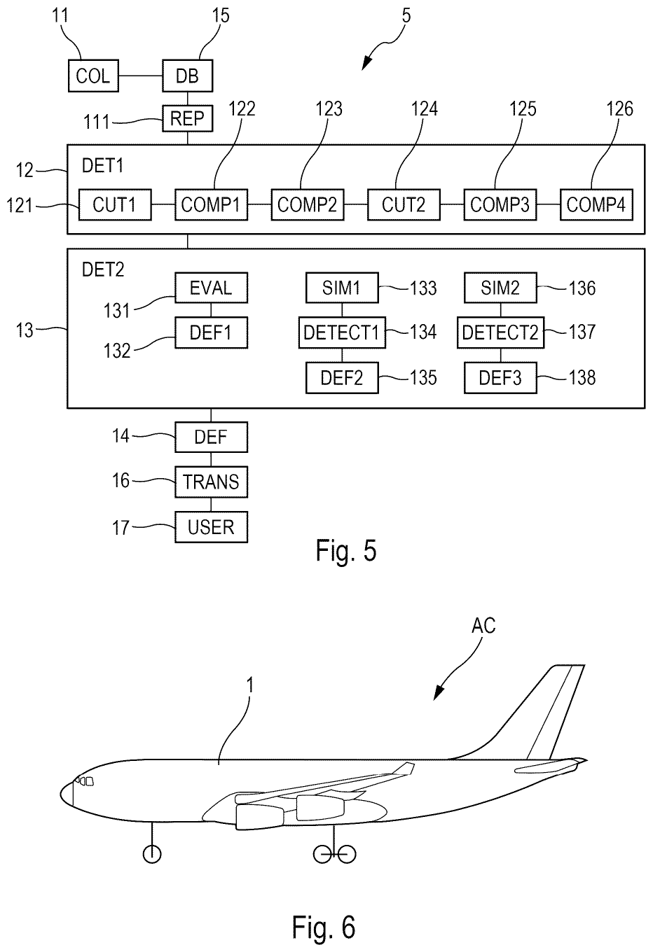

The disclosure herein relates also to a definition system S for defining a digital twin of an aircraft (FIG. 5). The definition system S can be implemented by a processor of a calculator, such as a computer.

The system S comprises:
the collecting unit 11 for collecting a plurality of corrosion incidents (6) on a plurality of aircraft AC,
the reporting unit 111 for reporting the plurality of corrosion incidents 6 collected on the digital twin 2,
the first determination unit 12 for determining zones 7, 72 associated with a corrosion risk level for each part 4 of the fuselage of the digital twin 2, the corrosion risk level of each of the zones 7, 72 being determined on the basis of the corrosion incidents 6 collected in each of the zones 7, 72 respectively,
the defining unit 14 for defining the digital twin 2 by defining a category of corrosion protection for each zone 7, 72 on the basis of the corrosion risk level associated with each of the zones 7, 72.

The system S can comprise the database 15 in which the plurality of

corrosion incidents 6 are stored. However, according to another embodiment, the database 15 can be included by another system distinct from the system S.

According to one embodiment, the first determining unit 12 comprises:
the first cutting sub-unit 121 for cutting each part 4 of the fuselage 1 according to a mesh of zones 70 comprising zones 7 of predetermined size,
   the first computing sub-unit 122 for calculating a corrosion incident rate for each zone 7 of the mesh of zones 70,
   the second computing sub-unit 123 for calculating, in each zone 7 of the mesh of zones 70 of a part 4, a corrosion risk level according to the corrosion incident rate calculated for the zone 7.

Moreover, the first determining unit 12 can further comprise:
the second cutting sub-unit 124 for cutting the part 4 according to a sub-mesh of zones 71 comprising zones 72 of predetermined size less than the predetermined size of the zones 7 of the mesh of zones 70,
the third computing sub-unit 125 for calculating a corrosion incident rate for each zone 72 of the sub-mesh of zones 71,
the fourth computing sub-unit 126 for calculating, for each zone 72 of the sub-mesh of zones 71 of the part 4, a corrosion risk level according to the corrosion incident rate calculated for each zone 72 of the sub-mesh of zones 71.

According to the other embodiment, the system S further comprises

the second determining unit 13 for determining at least one characteristic likely to cause corrosion in each of the zones 7, 72.

According to the first variant, the second determining unit 13 comprises:
the evaluating sub-unit 131 for evaluating, for each zone of a part 4, at least one galvanic incompatibility between materials from which each part 4 is likely to be manufactured, the materials being given by the digital twin 2,
the first defining sub-unit 132 for defining at least one galvanic incompatibility between the materials as being a characteristic likely to cause corrosion in a zone 7, 72 if the galvanic incompatibility or incompatibilities evaluated are greater than or equal to a predetermined galvanic compatibility.

According to the second variant, the second determining unit 13 comprises:
the first simulating sub-unit 133 for simulating, on the digital aircraft twin 2, movements likely to be undergone by the parts 4 during normal use of an aircraft AC,
the first detecting sub-unit 134 for detecting an initiation of corrosion in each zone 7, 72 in a protective coating covering the parts 4 following the movements simulated by the first simulating sub-unit 133,
   the second defining sub-unit 135 for defining, as a characteristic likely to cause corrosion in a zone 7, 72, at least one inadequacy of solidity of the protective coating if the corrosion has appeared in the zone 7, 72.

According to the third variant, the second determining unit 13 comprises:
the second simulating sub-unit 136 for simulating, on the digital aircraft twin 2, use of the aircraft AC under different atmospheric conditions,
the second detecting sub-unit 137 for detecting, in each zone 7, 72, at least one structural form 8 likely to lead to an accumulation of an electrolyte 10,
the third defining sub-unit 138 for defining, as a characteristic likely to cause corrosion in a zone 7, 72, the structural form or forms 8 likely to accumulate an electrolyte 10.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for defining a digital twin of an aircraft to improve a design of an aircraft structure to fight against corrosion of the aircraft structure, the digital aircraft twin presenting a three-dimensional digital model virtually defining an aircraft structure comprising aircraft structure parts, the method comprising:
a collection step implemented by a collecting unit for collecting a plurality of corrosion incidents on a plurality of aircraft;
a reporting step implemented by a reporting unit for reporting the plurality of corrosion incidents collected on the digital twin;
a first determination step implemented by a first determining unit for determining zones associated with a corrosion risk level for each part of the aircraft structure of the digital twin, the corrosion risk level of each of the zones being determined on a basis of the corrosion incidents collected in each of the zones respectively;
a definition step implemented by a defining unit for defining the digital twin by defining a category of corrosion protection for each zone according to the corrosion risk level associated with each of the zones;
a transmission step implemented by a transmitting unit for transmitting the digital twin to a user device.

2. The method of claim 1, wherein the first determination step comprises:
a first cutting sub-step implemented by a first cutting sub-unit for cutting each part of the aircraft structure according to a mesh of zones comprising zones of predetermined size;
a first computation sub-step implemented by a first computing sub-unit for calculating a corrosion incident rate for each zone of the mesh of zones;
a second computation sub-step implemented by a second computing sub-unit for calculating, in each zone of the mesh of zones of a part, a corrosion risk level according to the corrosion incident rate calculated for the zone.

3. The method of claim 2, wherein the first determination step further comprises sub-steps as follows implemented if at least two zones of the mesh of zones of a part show a corrosion incident rate difference greater than a predetermined difference:
a second cutting sub-step implemented by a second cutting sub-unit for cutting the part according to a sub-mesh of zones comprising zones of predetermined size less than the predetermined size of the zones of the mesh of zones;
a third computation sub-step implemented by a third computing sub-unit for calculating a corrosion incident rate for each zone of the sub-mesh of zones;
a fourth computation sub-step implemented by a fourth computing sub-unit for calculating, in each zone of the sub-mesh of zones of the part, a corrosion risk level according to the corrosion incident rate calculated for each zone of the sub-mesh of zones.

4. The method of claim 1, further comprising a second determination step implemented by a second determining unit for determining at least one characteristic likely to cause corrosion in each of the zones, the definition step being implemented to define the digital twin by further defining a type of protection according to the characteristic likely to cause corrosion in each of the zones.

5. The method of claim 4, wherein the second determination step comprises:
an evaluation sub-step implemented by an evaluating sub-unit for evaluating, for each zone of a part, at least one galvanic incompatibility between materials from which each part is likely to be manufactured, the materials being given by the digital twin;
a first definition sub-step implemented by a first defining sub-unit for defining at least one galvanic incompatibility between the materials as being a characteristic likely to cause corrosion in a zone if the galvanic incompatibility or incompatibilities evaluated are greater than or equal to a predetermined galvanic incompatibility.

6. The method of claim 5, wherein the type of protection defined in the definition step corresponds to a type of protection suited to the galvanic incompatibility or incompatibilities evaluated in the evaluation sub-step if the galvanic incompatibility or incompatibilities between the materials are defined as being a characteristic likely to cause corrosion.

7. The method of claim 4, wherein the second determination step comprises:
a first simulation sub-step implemented by a first simulating sub-unit for simulating, on the digital aircraft twin, movements likely to be undergone by the parts during normal use of an aircraft;
a first detection sub-step implemented by a first detecting sub-unit for detecting an initiation of the corrosion in each zone in a protective coating covering the parts following the movements simulated in the first simulation sub-step;
a second definition sub-step implemented by a second defining sub-unit for defining, as a characteristic likely to cause corrosion in a zone, at least one inadequacy of solidity of the protective coating if corrosion has appeared in the zone during the first simulation sub-step and been detected in the first detection sub-step.

8. The method of claim 7, wherein the type of protection defined in the definition step corresponds to a suitable type of protection against the initiation of corrosion if the inadequacy or inadequacies of solidity of the protective coating are defined as being a characteristic likely to cause corrosion.

9. The method of claim 4, wherein the second determination step comprises:
a second simulation sub-step implemented by a second simulating sub-unit for simulating, on the digital aircraft twin, use of the aircraft under different atmospheric conditions;
a second detection sub-step implemented by a second detecting sub-unit for detecting, in each zone, at least one structural form likely to lead to an accumulation of an electrolyte following the second simulation sub-step;
a third definition sub-step implemented by a third defining sub-unit for defining, as a characteristic likely to cause corrosion in a zone, the structural form or forms likely to accumulate the electrolyte.

10. The method of claim 4, wherein the type of protection defined in the definition step corresponds to a modification of the structural form or forms likely to accumulate an electrolyte in order for them to be no longer likely to accumulate the electrolyte if the structural form or forms likely to accumulate the electrolyte are defined as being a characteristic likely to cause corrosion.

11. A system for defining a digital twin of an aircraft to improve a design of an aircraft structure to fight against corrosion of the aircraft structure, the digital aircraft twin presenting a three-dimensional digital model virtually defining the aircraft structure comprising aircraft structure parts, the system comprising:
a collecting unit for collecting a plurality of corrosion incidents on a plurality of aircraft;
a reporting unit for reporting the plurality of corrosion incidents collected on the digital twin;
a first determining unit for determining zones associated with a corrosion risk level for each part of the aircraft structure of the digital twin, the corrosion risk level of each of the zones being determined on a basis of the corrosion incidents collected in each of the zones respectively;
a defining unit for defining the digital twin by defining a category of corrosion protection for each zone according to the corrosion risk level associated with each of the zones;
a transmitting unit for transmitting the digital twin to a user device.

12. The system of claim 11, further comprising a second determining unit for determining at least one characteristic likely to cause corrosion in each of the zones.
